(19) United States
(12) Patent Application Publication
(10) Pub. No.: US 2025/0110689 A1
(43) Pub. Date: Apr. 3, 2025

(54) LOCATION RECOMMENDATIONS BASED ON MEDIA PLAYBACK INFORMATION

(71) Applicant: Sonos, Inc., Goleta, CA (US)

(72) Inventors: Lizaveta OBADAVA, Chatenay-Malabry (FR); Ahmed Wadie MOUTAWAKIL, Boulogne-Billancourt (FR)

(21) Appl. No.: 18/895,007

(22) Filed: Sep. 24, 2024

Related U.S. Application Data
(60) Provisional application No. 63/586,252, filed on Sep. 28, 2023.

(51) Int. Cl. G06F 3/16; G10L 15/22

(52) U.S. Cl. CPC G06F 3/165; G10L 15/22

(57) ABSTRACT

Techniques for providing location indications are disclosed. In some examples, data indicating media content played back by media playback systems deployed at various locations and data indicating media content preferences of a user is used to provide indications of locations that may be relevant to the user. These indications can be provided via recommendations, advertisement, search results, social media feed, or in any other way. In this way, users can discover, browse, /or search places that play back content that the user will potentially like.

### CROSS-REFERENCE TO RELATED APPLICATIONS

This application claims the benefit of and priority to U.S. Provisional Patent Application Ser. No. 63/586,252 filed on 28 Sep. 2023 and entitled “LOCATION RECOMMENDATIONS BASED ON MEDIA PLAYBACK INFORMATION,” which application is expressly incorporated herein by reference in its entirety.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 1C is a block diagram of a playback device.

FIG. 1D is a block diagram of a playback device.

FIG. 1E is a block diagram of a bonded device.

FIG. 1F is a block diagram of a network microphone device.

FIG. 1G is a block diagram of a playback device.

FIG. 1H is a partial schematic diagram of a control device.

FIG. 2A includes a representation of a computing system, media service accounts, media playback systems, users and locations, in accordance with embodiments described herein.

FIG. 2B illustrates a first example set of location indications that can be provided to a user, in accordance with embodiments described herein.

FIG. 2C illustrates a second example set of location indications that can be provided to a user, in accordance with embodiments described herein.

FIG. 3 illustrates a flowchart for a set of methods of providing location indications based on media playback information, in accordance with embodiments described herein.

FIG. 4 illustrates a first example user interface, in accordance with embodiments described herein.

FIG. 5A illustrates a second example user interface, in accordance with embodiments described herein.

FIG. 5B illustrates a third example user interface, in accordance with embodiments described herein.

FIG. 6 illustrates a flowchart for a set of methods of displaying a user interface via which locations can be filtered based on the user's preferences, in accordance with embodiments described herein.

FIG. 7 illustrates a fourth example user interface, in accordance with embodiments described herein.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

In personal or more private environments, such as at home or when playing back content from a personal device, a user may be able to control the media content played back so that it matches their preferences. However, in more public environments such as a store or a restaurant, users typically don't have the ability to control the media content that is played back because they don't have access to the media playback system or don't have the means to control it. People usually enjoy when the media content played back in these public environments is to their liking, but satisfying users' tastes can be challenging, particularly for places that receive a high rotation of users or customers who may have very different media content preferences.

Some solutions to these challenges involve allowing users some control or influence over the media content that is played back at a particular place. This may involve allowing the user to select and/or add media content for playback at the particular place, or curating the media content that is played back at the particular place based on known user data such as user preferences or demographics. However, there may be instances in which users have no influence whatsoever over the media content played back at the particular place. Furthermore, some solutions involve physical proximity to the particular place where the media content is played back and/or direct interaction with the media playback system at the particular place. However, there may be instances in which users are not (or at least not yet) physically present in the particular place and/or are not interacting with the media playback system in the particular place. In those cases, it would be interesting to provide the user with information about the type of media content played back so that users can make an assessment and decide whether to visit the particular place. Furthermore, it would be interesting to provide the user with options to find and filter places based on the media content played back at those places. Particularly, it would be interesting to provide the user with options to find places that play content that the user potentially likes.

This disclosure describes techniques that facilitate finding places based on the media content played back at such places, and/or based on the media content that the users consume or like. In some examples, data indicating media content played back by media playback systems deployed at various locations (e.g., commercial locations, hotels, restaurants, retail stores) and/or data indicating media content preferences of a user can be used to provide indications of locations that may be relevant to the user. These indications can be provided via recommendations, advertisements, search results, social media feeds, or in any other way. In this way, users can discover, browse, and/or search places that play back content that the user will potentially like.

For example, a user may be looking for a gym in a particular area. From user data, it can be determined that this user may enjoy listening to pop music when working out. In this way, indications of gyms that play back (and/or are currently playing back) pop music can be provided to this user. However, the locations identified for this user may not be the best suited for a second user who likes to listen to heavy metal at the gym. Different indications of different locations (e.g., gyms that play back heavy metal) can be provided to the second user. In this way, users may be able to discriminate between places that may potentially play back content they like and places that may not.

In some instances, a computing system is provided. The computing system comprises at least one processor and at least one non-transitory computer-readable medium comprising program instructions that are collectively executable by the at least one processor such that the computing system is configured to: receive, for a first set of media playback systems, playback data corresponding to media content played back via each media playback system in the first set of media playback systems; receive, for a second set of media playback systems, playback data corresponding to media content played back via each media playback system in the second set of media playback systems, wherein each media playback system in the second set of media playback systems is associated with at least one location; and based on at least one playback data similarity between: (i) playback data corresponding to a first media playback system from the first set of media playback systems, and (ii) playback data corresponding to one or more second media playback systems from the second set of media playback systems: provide, via a user interface associated with the first media playback system, one or more location indications corresponding to one or more locations associated with the one or more second media playback systems.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

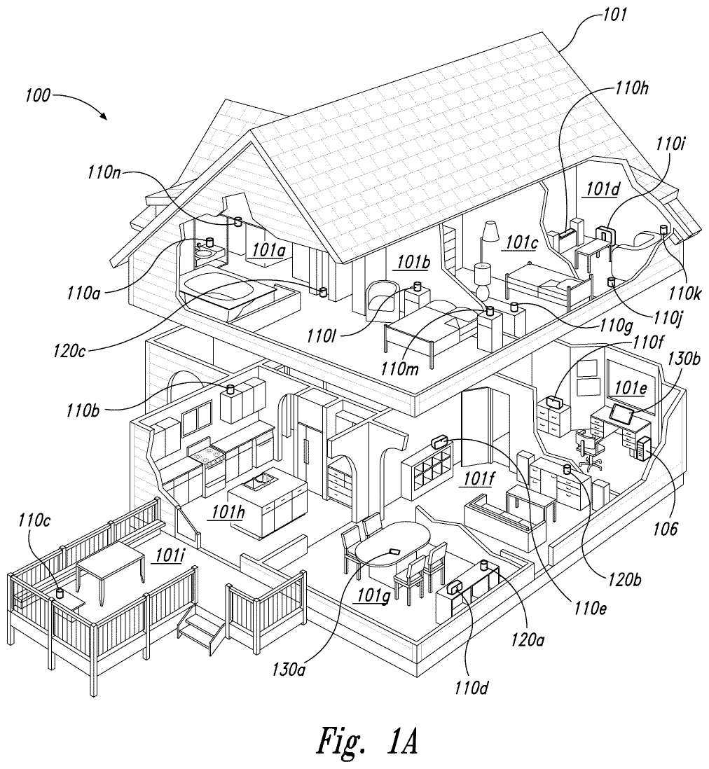

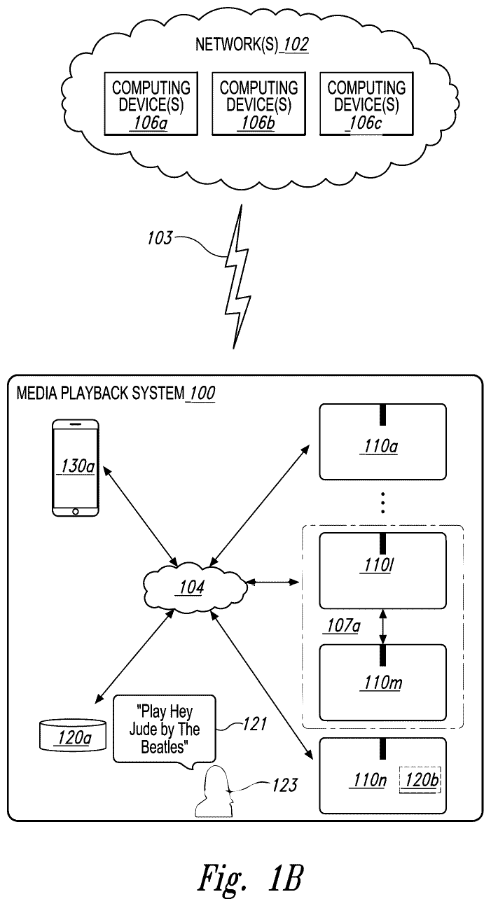

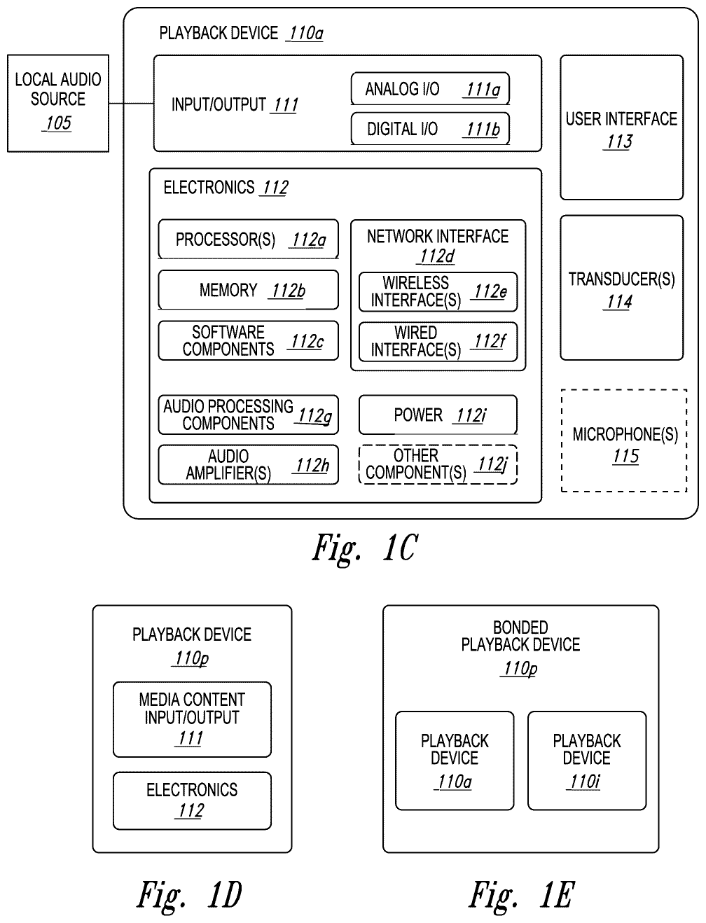

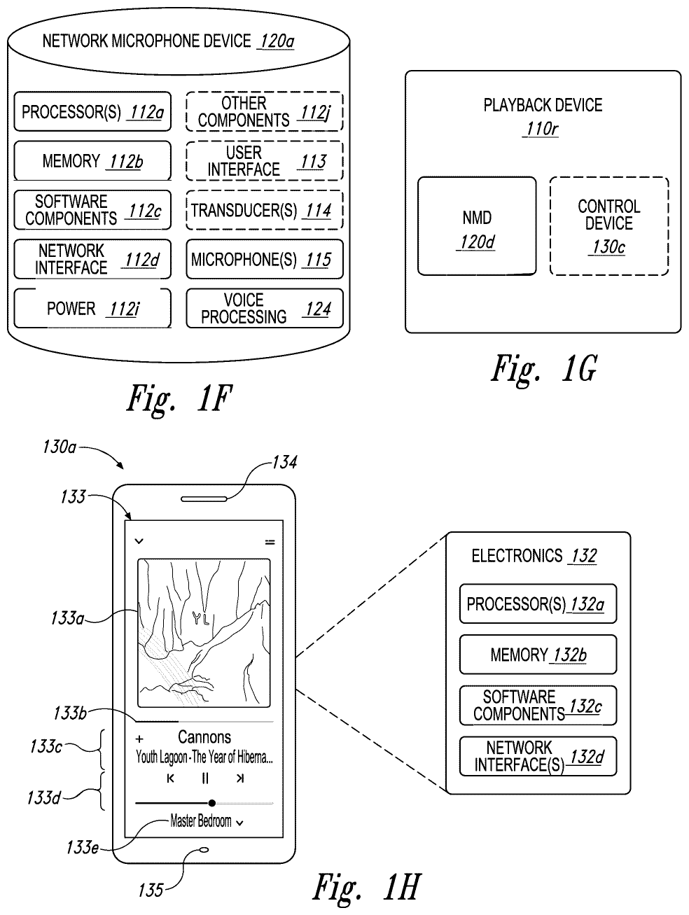

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles and other features shown in the Figures are merely illustrative of particular embodiments of the disclosed technology. Accordingly, other embodiments can have other details, dimensions, angles and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices 120 (“NMDs”) (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term “NMD” (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some embodiments, for example, the media playback system 100 is configured to play back audio from a first playback device (e.g., the playback device 100a) in synchrony with a second playback device (e.g., the playback device 100b). Interactions between the playback devices 110, NMDs 120, and/or control devices 130 of the media playback system 100 configured in accordance with the various embodiments of the disclosure are described in greater detail below with respect to FIGS. 1B-1H.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed, to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some aspects, a single playback zone may include multiple rooms or spaces. In certain aspects, a single room or space may include multiple playback zones.

In the illustrated embodiment of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B and 1E.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some embodiments, the cloud network 102 is further configured to receive data (e.g., voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHZ, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household communication network (e.g., a household WiFi network). In some embodiments, the links 103 and the network 104 comprise one or more of the same networks. In some aspects, for example, the links 103 and the network 104 comprise a telecommunication network (e.g., an LTE network, a 5G network). Moreover, in some embodiments, the media playback system 100 is implemented without the network 104, and devices comprising the media playback system 100 can communicate with each other, for example, via one or more direct connections, PANs, telecommunication networks, and/or other suitable communication links. The network 104 may be referred to herein as a “local communication network” to differentiate the network 104 from the cloud network 102 that couples the media playback system 100 to remote devices, such as cloud services.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110.

The media playback system 100 includes the NMDs 120a and 120d, each comprising one or more microphones configured to receive voice utterances from a user. In the illustrated embodiment of FIG. 1B, the NMD 120a is a standalone device and the NMD 120d is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) facilitate one or more operations on behalf of the media playback system 100.

In some aspects, for example, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103.

In response to receiving the voice input data, the computing device 106c processes the voice input data (i.e., “Play Hey Jude by The Beatles”), and determines that the processed voice input includes a command to play a song (e.g., “Hey Jude”). In some embodiments, after processing the voice input, the computing device 106c accordingly transmits commands to the media playback system 100 to play back “Hey Jude” by the Beatles from a suitable media service (e.g., via one or more of the computing devices 106) on one or more of the playback devices 110. In other embodiments, the computing device 106c may be configured to interface with media services on behalf of the media playback system 100. In such embodiments, after processing the voice input, instead of the computing device 106c transmitting commands to the media playback system 100 causing the media playback system 100 to retrieve the requested media from a suitable media service, the computing device 106c itself causes a suitable media service to provide the requested media to the media playback system 100 in accordance with the user's voice utterance.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises an High-Definition Multimedia Interface (HDMI) interface and/or cable. In some embodiments, the digital I/O 111b includes one or more wireless communication links comprising, for example, a radio frequency (RF), infrared, WiFi, Bluetooth, or another suitable communication protocol. In certain embodiments, the analog I/O 111a and the digital 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The electronics 112 are configured to receive audio from an audio source (e.g., the local audio source 105) via the input/output 111 or one or more of the computing devices 106a-c via the network 104 (FIG. 1B)), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases).

The processors 112a can comprise clock-driven computing component(s) configured to process data, and the memory 112b can comprise a computer-readable medium (e.g., a tangible, non-transitory computer-readable medium loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 excludes the network interface 112d altogether and transmits and receives media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, a digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, SONOS, Inc. presently offers (or has offered) for sale certain playback devices including, for example, a “SONOS ONE,” “PLAY:1,” “PLAY:3,” “PLAY:5,” “PLAYBAR,” “PLAYBASE,” “CONNECT: AMP,” “CONNECT,” and “SUB.” Other suitable playback devices may additionally or alternatively be used to implement the playback devices of example embodiments disclosed herein. Additionally, one of ordinary skilled in the art will appreciate that a playback device is not limited to the examples described herein or to SONOS product offerings. In some embodiments, for example, one or more playback devices 110 comprises wired or wireless headphones (e.g., over-the-ear headphones, on-ear headphones, in-ear earphones). In other embodiments, one or more of the playback devices 110 comprise a docking station and/or an interface configured to interact with a docking station for personal mobile media playback devices. In certain embodiments, a playback device may be integral to another device or component such as a television, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio components 112g (FIG. 1C), the amplifiers 114, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing 124, and only a portion of the components of the electronics 112 described above with respect to FIG. 1B. In some aspects, for example, the NMD 120a includes the processor 112a and the memory 112b (FIG. 1B), while omitting one or more other components of the electronics 112. In some embodiments, the NMD 120a includes additional components (e.g., one or more sensors, cameras, thermometers, barometers, hygrometers).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other embodiments, however, the playback device 110r receives commands from another control device (e.g., the control device 130a of FIG. 1B).

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing 124 receives and analyzes the microphone data to determine whether a voice input is present in the microphone data. The voice input can comprise, for example, an activation word followed by an utterance including a user request. As those of ordinary skill in the art will appreciate, an activation word is a word or other audio cue signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing 124 monitors the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

d. Suitable Control Devices

FIG. 1H is a partial schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™, an Android phone) on which media playback system controller application software is installed. In some embodiments, the control device 130a comprises, for example, a tablet (e.g., an iPad™), a computer (e.g., a laptop computer, a desktop computer), and/or another suitable device (e.g., a television, an automobile audio head unit, an IoT device). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 302 to perform those functions. The software components 132c can comprise applications and/or other executable software configured to facilitate control of the media playback system 100. The memory 112b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 304 to one or more of the playback devices 100. The network interface 132d can also transmit and/or receive configuration changes such as, for example, adding/removing one or more playback devices 100 to/from a zone, adding/removing one or more zones to/from a zone group, forming a bonded or consolidated player, separating one or more playback devices from a bonded or consolidated player, among others.

The user interface 133 is configured to receive user input and can facilitate control of the media playback system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as playback device and an NMD. In other embodiments, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones.

III. Location Recommendations based on Media Playback Information

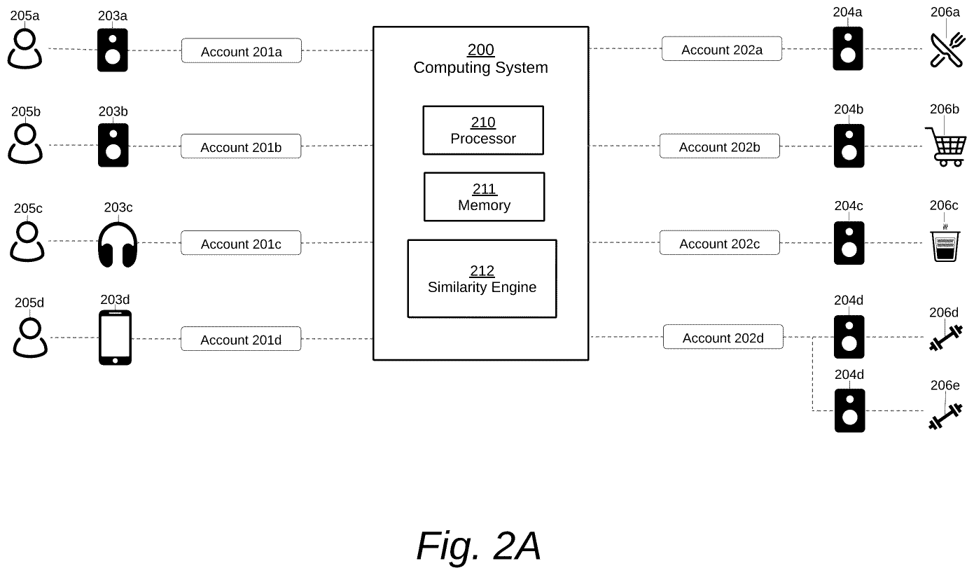

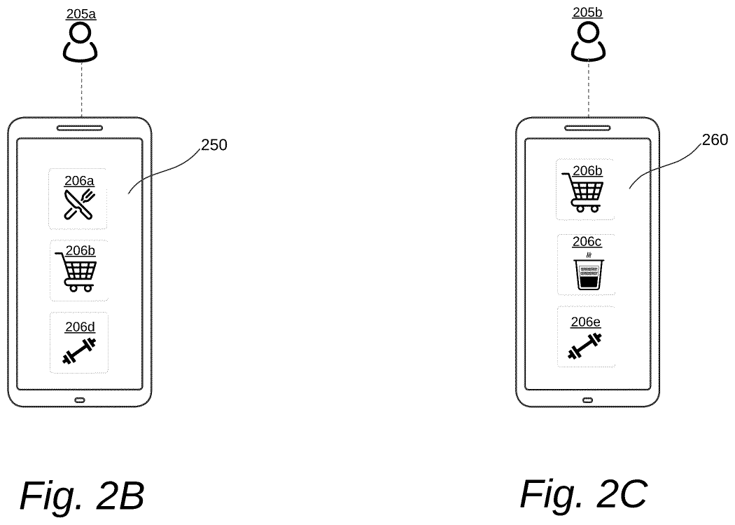

FIG. 2A includes a representation of a computing system 200 comprising a processor 210, a memory 210 and a similarity engine 212. FIG. 2A also includes a representation of a first set of accounts 201 and a second set of accounts 202, a first set of media playback systems 203 and a second set of media playback system 204, a set of users 205 and a set of locations 206.

The computing system 200 can comprise one or more computing devices (e.g., servers). The computing system and/or computing devices can comprise one or more processors (e.g., processor 210) and one or more non-transitory computer-readable media (e.g., memory 211) comprising program instructions that are collectively executable by the one or more processors such that the computing system/devices are configured to perform any actions described herein. The computing system 200 can comprise one or more of: the network 102 and/or any of the computing devices 106 described with reference to FIG. 1B, a computing system associated with a media playback system provider such as Sonos, a computing system associated with a media content provider, a computing system associated with a social media service, a computing system associated with any one or more service providers, etc.

The computing system 200 can be associated with one or more accounts, such as first accounts 201a, 201b, 201c, 201d . . . 201n (collectively referred to herein as “accounts 201” or “first accounts 201”) and second accounts 202a, 202b, 202c, 202d . . . 202n (collectively referred to herein as “accounts 202” or “second accounts 202”). As indicated by the ellipsis, any number of accounts can be associated with the computing system 200. The accounts 201 and 202 can be accounts with the computing system and/or accounts with/of a service associated with the computing system (e.g., a service managed by or running on the computing system). For example, one or more of the accounts 201 and 202 can be accounts of a media playback system provider (e.g., Sonos accounts), accounts of a media streaming service (e.g., Sonos Radio accounts, Spotify accounts, etc.), or accounts with any other provider/service which can be accessed via the computing system 200. The accounts and/or data associated with the accounts (e.g., data corresponding to credentials, profile data, preferences, configuration, activity logs, playback history, playback activity, etc.) can be stored by the computing system and/or in one or more storage devices accessible to the computing system 200 (e.g., memory 211).

The computing system 200 can additionally or alternatively be associated with one or more media playback systems, such as first media playback systems 203a, 203b, 203c, 203d . . . 203n (collectively referred to herein as “media playback systems 203” or “first media playback systems 203”) and second media playback systems 204a, 204b, 204c, 204d . . . 204n (collectively referred to herein as “media playback systems 204” or “second media playback systems 204”). As indicated by the ellipsis, any number of media playback systems can be associated with the computing system 200. Each of the media playback systems 203 and 204 can include one or more playback devices. The media playback systems 203 and 204 can be the same or similar to the media playback system 100 described with reference to FIGS. 1A-1H.

In some instances, one or more of the accounts 201 and 202 can be associated with media playback systems such as any of the media playback systems 203 and 204. In some instances, the accounts 201 and 202 can be accounts of (and/or registered with) the media playback systems 203 and 204. In some instances, the media playback systems 203 and 204 can be provided by a media playback system provider (e.g., Sonos media playback systems), and the accounts 201 and 202 can be accounts of the media playback system provider (e.g., Sonos accounts) and/or any other accounts registered with the media playback system (e.g., streaming service accounts). Data associated with the media playback systems (e.g., accounts, credentials, profile data, activity logs, playback data corresponding to playback history and activity, etc.) can be stored in one or more storage devices accessible to the computing system 200 (e.g., memory 211).

One or more of the accounts 201 and 202 and/or media playback systems 203 and 204 can be associated with one or more users, such as users 205a, 205b, 205c, 205d . . . 205n (collectively referred to herein as “users 205”). As indicated by the ellipsis, any number of users can be involved. Users 205 can be users of respective accounts 201 and 202 and/or users of respective media playback systems 203 and 204. In some instances, more than one user can be associated with the same account and/or the same media playback system. For example, the account can be a multi-user account (e.g., a family or workplace account). As another example, the media playback system can be shared among multiple users (e.g., in a household or workplace, or at a location). User data (e.g., a user profile, preferences, playback activity, etc.) can be stored in one or more storages accessible to the computing system 200 (e.g., memory 211).

One or more of the accounts 201 and 202 and/or media playback systems 203 and 204 can be associated with one or more locations (e.g., places), such as locations 206a, 206b, 206c, 206d, 206e . . . 206n (collectively referred to herein as locations 206). As indicated by the ellipsis, any number of locations can exist. A media playback system can be associated with a location when one or more playback devices are deployed/installed at the location. In some instances, a media playback system can be associated with a location when one or more playback devices are connected to a local area network (LAN) of the location. In some instances, a media playback system can be associated with a location by associating one or more location identifiers (e.g., a unique location ID, a location name, a location address, etc.) and/or one or LAN identifiers (e.g., a DHCP Server MAC address, an IP address, SSID, etc.) with the one or more playback devices in the location and/or with one or more system and/or device identifier corresponding to the playback devices in the location. Data representing this association can be stored by the computing system 200.

A location, as used herein, can comprise a physical location or a place. Each location can be associated with one or more of a unique location identifier, location name, location address, or any other data identifying the location. In some instances, each location comprises, provides, or is otherwise associated with one or more local area networks (LANs), and the playback devices deployed at a location are connected to the one or more LANs. In some instances, playback devices that are connected to the same LAN can be said to be in the same location. Other examples of locations are provided in, for example, U.S. patent application Ser. No. 18/635,422, entitled “Management of Media Playback System Splits and Location Designation for Partitions of a Media Playback System,” which is incorporated herein by reference in its entirety.

In some instances, the locations comprise one or more of a commercial location, a business location, a public location, or a non-residential location. For example, media playback system 204a is associated with location 206a, which can be, for example, a restaurant. As another example, media playback system 204b is associated with location 206b, which can be, for example, a store. As another example, media playback system 204c is associated with location 206c, which can be, for example, a coffee shop. In some instances, one or more of the accounts 201 and 202 and/or media playback systems 203 and 204 can be associated with more than one location (e.g., the media playback system may be distributed across two or more locations). For example, media playback system 204d is associated with a location 206d and a location 206e, which can be, for example, two branches of a same business such as two studios of a gym chain.

In some instances, the locations comprise one or more of a private or a residential location. For example, any of the media playback systems such as media playback systems 203a and 203b can optionally be associated with one or more locations, such as the user's house or office. In some instances, one or more accounts/systems may not be associated with any location. For example, media playback system 203c can comprise a portable playback device such as headphones or any other type of portable playback device that is not necessarily associated with any particular location. As another example, account 201d may be a media streaming service account that user 205d uses on their phone or other user device 203e, which is not necessarily associated to any particular location.

The accounts 201 and 202 and/or media playback systems 203 and 204 associated with computing system 200 can be of different types. These types of accounts/systems can be different in one or more aspects. For example, the accounts/systems can have one or more different attributes, capabilities, features, etc. In some instances, some accounts such as first accounts 201 can be individual or family user accounts, intended for personal or residential usage (e.g., to be used by users such as users 205). Some other accounts such as second accounts 202 can be business accounts, intended for commercial or non-residential usage (e.g., to be used at places such as locations 206). In one example, first accounts 201 can be Sonos users' accounts and second accounts 202 can be Sonos' business accounts. In this sense, first accounts 201 can be associated with individual users, and second accounts 202 can be associated with media playback systems deployed in commercial or non-residential locations.

The computing system 200 can be configured to provide indications of locations (such as locations 206) to one or more users (such as users 205). In some instances, the computing system can identify one or more locations relevant to a particular user and indicate, recommend or otherwise surface the identified locations to users. For example, the computing system can indicate places such as restaurants, hotels, bars and cafes to users. The computing system can indicate places to a user based on various factors. For example, the computing system can indicate places based on the type of media content played back at those places and the type of media content that a particular user prefers or consumes.

FIGS. 2B and 2C illustrate two example sets of location indications 250 and 260 that can be provided to users 205a and 205b, respectively. In the example of FIG. 2B, the computing system 200 can determine that locations 206a, 206b and 206d play back (currently and/or usually) media content that matches the media content consumed by user 205a. In this way, the computing system can provide an indication of locations 206a, 206b and 206d to user 205a. Similarly, in the example of FIG. 2C, the computing system 200 can determine that locations 206b, 206c and 206e play back (currently and/or usually) media content that matches the media content consumed by user 205b. In this way, the computing system can provide an indication of locations 206b, 206c and 206e to user 205b. The users can then receive the indications and decide whether to visit one of those locations. The location indications 250 and 260 can be provided via a user interface of a device associated with the user accounts, as will be explained below in more detail. The location indications can be provided in any form such as location recommendations, search results, instant notifications, text messages, emails, social media posts or feed, advertisement, etc.

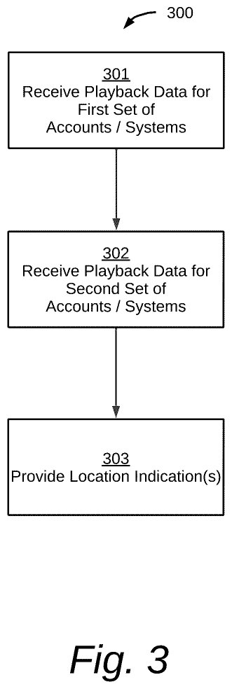

FIG. 3 illustrates a flowchart 300 for a set of methods of providing location indications (such as location indications 250 and 260 in FIGS. 2B and 2C), based on media playback information, in accordance with embodiments described herein. The different blocks of the method can be conducted by the computing system 200 and/or any one or more computing devices comprising at least one processor and at least one non-transitory computer-readable medium comprising program instructions that are collectively executable by the at least one processor such that the computing system/device(s) is configured to conduct the method.

Flowchart 300 comprises blocks 301 and 302 of receiving playback data corresponding to one or more accounts and/or one or more media playback systems. At block 301, the computing system can receive playback data for a first set of accounts and/or a first set of media playback systems (such as first accounts 201 and/or first media playback systems 203). At block 302, the computing system can receive playback data for a second set of accounts and/or a second set of media playback systems (such as second accounts 202 and/or second media playback systems 204). Blocks 301 and 302 can be executed concurrently and/or in no particular order.

Playback data can include any data related to the playback activity of the accounts 201 and 202 and/or media playback systems 203 and 204. For example, playback data can comprise data corresponding to media content played back via each account/system. Playback data can comprise data corresponding to media content currently being played back via each account/system, and/or media content played back over a period of time (e.g., in the last hour, the last 24 hours, this year, last week, historically, etc.). As another example, playback data can comprise data indicating playback actions performed via the accounts/systems, such as initiating or stopping playback, searching, browsing, selecting media content for playback, providing feedback on media content, saving media items in playlists, etc. As another example, playback data can include data indicating a playback history, such as data indicating media items played back via the accounts/systems over a period of time. As another example, playback data can include any preferences indicated for the accounts/media playback systems. As another example, playback data can include playback context data, such as a date, a time, a room, or a location in which media content is played back. As another example, playback data can include media playback system configuration data such as the volume at which media content was played back, the playback device (or group of playback devices) used for playback, whether the playback devices are members of a bonded zone, etc.

Computing system 200 can receive, store and/or manage playback data for any of the accounts 201 and 202 and/or media playback systems 203 and 204 at any time. Playback data for each media playback system can be received from/via any device associated with the respective media playback system, such as a playback device or a control device of the media playback system. Playback data can additionally or alternatively be received from/via any device registered with the respective account such as a user device registered with a streaming service account. Playback data can be received directly from a device or via one or more intermediary devices such as one or more intermediary servers.

Playback data can be received individually for/from each account and/or media playback system, in one or more messages. The one or more messages can comprise other data in addition to the playback data such as data identifying the media playback system and/or account to which the playback data is associated, data identifying a location associated with the playback data, data identifying a user, or any context. The one or more messages can be received periodically or aperiodically as there are updates or events corresponding to the account and/or media playback system, and the computing system can receive and store this data in association with any playback data already received for this account or system. For example, one or more messages can be received at a first time indicating a payback event such as that playback has been started. Multiple additional messages can be received at different times indicating requests for media content for playback, changes to configurations, preferences or settings, playback actions, etc.

Flowchart 300 comprises a block 303 of providing one or more location indications corresponding to one or more locations associated with one or more media playback systems. As mentioned before, the location indications can be indications of places where the media playback systems are deployed and/or with which the media playback system is associated. In some instances, the computing system provides location indications corresponding to commercial or non-residential locations (e.g., locations 206 in FIG. 2) to users registered with the computing system (e.g., users 205).

The one or more location indications can be provided based on the playback data received in blocks 301 and 302. In some instances, the one or more location indications are provided based on similarity of one or more aspects of the playback data between two or more accounts. For example, the computing system can provide an indication of a particular location to a user based on a determination that the particular location and the user play back similar media content.

The computing system 200 can use the playback data received in blocks 301 and 302 of flowchart 300 to identify and/or determine one or more similarities in the playback data corresponding to different media playback systems and/or accounts. The playback data similarity can comprise a similarity in the media content consumed via the accounts (e.g., media content played back and/or caused to be played back via the accounts, media content searched by a user of the account, media content shared by a user of the account, media content for which positive or negative preferences has been indicated by the users, etc.). For example, two or more accounts can consume one or more same or similar media items, one or more same or similar artists or creators, one or more same or similar genres, one or more same or similar shows, etc.

In some instances, the one or more similarities can be determined by determining that some of the media content consumed by two different accounts is the same. For example, media items can have common metadata such as a common title and artist so that it can be identified that they are the same media item. As another example, media items can have a same identifier (e.g., URL, URI, track ID) so that it can be identified that they are the same media item. In some instances, even if it is not determined that the media items are the same, the one or more similarities can be determined by determining that some of the media content consumed by two different accounts is similar. Media content can be considered to be similar when the media content has one or more attributes in common. Examples of similar media content comprise different versions of the same media item, different media content/items from a same creator or artist, different media content/items about a same topic, different media content/items of a same genre, etc.

In some instances, the playback data similarity comprises a similarity between characteristic(s) and/or attribute(s) of a media item played back by a first media playback system (e.g., system 203a corresponding to user 201a) and characteristic(s) and/or attribute(s) of a media item played back by the one or more second media playback systems (e.g., systems 204a, 204b, and 204d corresponding to locations 206a, 206b and 206d). The playback data similarity can additionally or alternatively comprise a similarity between a type of media content played back by the first media playback system and a type of media content played back by the one or more second media playback systems, a similarity between metadata corresponding to a media item played back by the first media playback system and metadata corresponding to a media item played back by the one or more second media playback systems, etc.

In some instances, the playback data can correspond to media content played back via one or more different streaming services so that the playback data similarity comprises a similarity between media content played back via a first streaming service associated with a first account/system and media content played back via a second (maybe different) streaming service associated with a second account/system. As mentioned before, some of the accounts (e.g., first accounts 201) can be personal accounts and some of the accounts (e.g., second accounts 202) can be business accounts. In this way, the first media streaming service can comprise a consumer streaming service and the second streaming service can comprise a commercial streaming service. Block 303 of method 300 can comprise determining a similarity between the media content consumed across the different streaming services, and providing the location indications accordingly. Examples of how to determine similarities between media content across different streaming services are described in U.S. Pat. No. 9,286,384, filed Sep. 21, 2011, entitled “Methods and Systems to Share Media” and U.S. Pat. No. 10,331,736, filed Mar. 21, 2014, entitled “Facilitating streaming media access via a media-item database”, all of which are incorporated by reference herein in their entireties.

In some instances, the computing system can identify one or more similarities by identifying accounts and/or media playback systems that have played back a particular media content and/or type of media content (e.g., a particular media item, artist, creator, genre, show, mood, topic, playlist, etc.) more than a threshold number of occasions. For example, two or more media playback systems can have played back the same or similar media item more than a threshold number of occasions. In this case, the computing system can determine a similarity by determining that two or more media playback systems have played back the same or similar content in more than the threshold number of occasions. The threshold can be as low as one (e.g., media playback systems that have played back the same or similar content at least once), or as high as desired (e.g., media playback systems that have played back the same or similar media content more than 50, 100, or 1000 times). In some instances, the higher the threshold the stronger the similarity between the media playback systems. In some instances, the threshold can be considered over a period of time. For example, the threshold can consider the number of times that a media playback system has played back particular type of media content in the last 24 hours, 1 week, 30 days, a year, historically, etc.

Different similarity tiers can exist to determine the strength level of a location indication provided to a user. For example, if a user has played back a certain kind of media content a low threshold number of occasions over a period of time (e.g., recently) or frequently skips the certain kind of media content, a location recommendation for a location that plays back (usually or currently) the same or similar content can be provided with an indication of a low match. However, if a user has played back the certain type of media content more than a large threshold number of occasions over a period of time (e.g., recently), the location recommendation can be provided with an indication of a strong match. Similarly, the content played back at the locations can be rated in order to provide a strength indication to the user. If a location plays back media content that matches the user preferences often (e.g., more than a threshold number of occasions over a particular time period), a strong match indicator can be provided to the user with the location indication. Similarly, a “no match” or “low match” indicator can be provided for locations that play back content that does not match the user's preferences. In this way, the user may decide where not to go.

Multiple similarity tiers can exist based on the level of similarity between the playback data of the different accounts. For example, different similarity tiers can be associated to different similarity scores, as will be described in more detail below. In some instances, similarity tiers can be represented on or associated with a scale. For example, similarity tiers can be represented on a scale of 1 through 5 where 1 represents low to no similarity (e.g., match lower than 20%) and 5 represents high to perfect similarity (e.g., match higher than 80%). Other examples are possible.

The computing system can implement a similarity algorithm or any other kind of recommendation or matching algorithm to find locations that match the preferences of a particular user. In some instances, the computing system implements a similarity engine 212. The similarity engine can comprise a software module running on the computing device that causes the computing device to determine similarities between playback data corresponding to different accounts. In some instances, the similarity engine can receive playback data from two or more accounts as inputs, and calculate a similarity score between the two or more accounts. The similarity score can be calculated by comparing the media content played back by the two or more accounts in a time period and determining the percentage of media content match with respect to the mismatch and/or with respect to all the media content consumed by the accounts in the time period. The similarity score can be calculated by determining the number of times (or amount of time) that a particular account has played back a type of media content over a particular time period. Other examples are possible. In this way, the similarity engine can provide a set of locations relevant to a particular user based on the similarity score.

Referring back to FIG. 2B, the computing system 200 (e.g., via a similarity engine 212) can determine that locations 206a, 206b and 206d play back content similar to what user 205a likes. This determination can be based on playback data received for user 205a in block 301 and locations 206a, 206b and, 206d in block 302 of method 300. The determination can be conducted for any number of users and locations. The result of the determination can comprise any number of locations.

In the example illustrated in FIG. 2B, the computing system can provide location indications based on similarity between the playback data corresponding to a first account (e.g., 201a corresponding to user 205a) from the first set of accounts 201 and playback data corresponding to one or more second accounts (e.g., 202a, 202b and 202d corresponding to locations 206a, 206b and 206d) from the second set of accounts 202. The one or more location indications can correspond to the one or more locations (e.g., locations 206a, 206b and 206d) associated with one or more second accounts (e.g., locations 202a, 202b and 202d).

Similarly, FIG. 2C illustrates another example where the computing system 200 determines that locations 206b, 206c and 206e play back content similar to what user 205b likes. In this example, the computing system can provide location indications based on similarity between playback data corresponding to a first media playback system (e.g., 203b corresponding to user 205b) from the first set of media playback systems 203 and playback data corresponding to one or more second media playback systems (e.g., 204b, 204c and 204d corresponding to locations 206b, 206c and 206e) from the second set of media playback systems 204. In those examples, the one or more location indications can correspond to the one or more locations (e.g., locations 206b, 206c and 206e) associated with the one or more second media playback systems (e.g., 204b, 204c and 204d).

In some instances, out of all the available locations, there may only be a subset of locations that match or are relevant to a user's profile, and the subset of matching locations can be included in location recommendations and surfaced to the particular users. The locations that are not considered a match for the particular user may not be relevant or displayed to the particular user. For example, and with reference back to FIGS. 2A-2C, the subset of relevant second media playback systems can include media playback systems 204a, 204b and 204d associated with locations 206a, 206b and 206d determined to be relevant to user 205a. The media playback system 204c may be associated with a location that may not be as relevant to the user 205a. As a result, location indications 250 include indications for the locations associated with media playback systems 204a, 204b, and 204d and exclude indications for the remaining locations. In this way, the media playback systems 204a, 204b and 204d associated with the locations indicated for the user 205a excludes one or more media playback systems from the second set of media playback systems 204. Similarly, the location indications 250 exclude indications corresponding to the additional media playback systems.

The one or more location indications can exclude an indication corresponding to the additional media playback systems based on a lack of playback data similarity between playback data corresponding to the user and playback data corresponding to additional media playback systems. For example, media playback system 204c can play back media content at location 206c which is not similar or relevant to the media content the user 205a consumes (e.g., media content that the user has played back less than a threshold number of occasions such as zero or a few times, media content for which the user has indicated negative preferences, media content for which the user has not indicated positive preferences, media content that the user has skipped, etc.). In this way, computing system 200 can exclude an indication of location 206c when recommending locations to the user 205a. Alternatively, the computing system can provide a location indication corresponding to location 206c with a “low match” indication.

Because the location indications are based on the playback data received for each account/media playback system, different users can receive a different set of location indications based on their playback profiles. As illustrated in the example of FIG. 2C, the computing system can provide, via a user interface associated with a different account or media playback system (e.g., account 201b or system 203b associated with user 205b), location indications 260 corresponding to locations 206b, 206c and 206e which are different than location indications 250 provided to user 205a in FIG. 2B. As explained before, the location indications can be based on similarity between playback data between user 205b and locations 206b, 206c and 206e.

Even if the playback data is different and the set of location recommendations is different for different users/accounts, there can be some overlap (e.g., of at least one location). For example, both users 205a and 205b can consume content from a same artist, but each user can consume otherwise different content. In some instances, the location indications provided to different users comprise at least one common location indication. For example, location indications 250 provided to user 205a and location indications 260 provided to user 205b both comprise an indication of location 206b.

In some instances, the locations indicated to one user can be different from the locations indicated to another user. For example, location indications 250 provided to user 205a comprise indications of locations 206a and 206d while location indications 260 provided to user 205b comprise indications of different locations 206c and 206e). In this way, different users of different accounts and/or different media playback systems can receive none, or one or more of, the same location indications. The location indications for different users can then comprise at least one location indication different from any of the location indications provided to another user(s).

As mentioned before, one or more accounts and/or media playback systems can be multi-location accounts and/or multi-location media playback systems, which are associated with more than one location. For example, account 202d and respective media playback system 204d are associated with a first location 206d and a second location 206e. Multi-location media playback systems can comprise one or more playback devices associated with each location. For example, multi-location media playback system 204d can comprise one or more first playback devices associated with the first location 206d and one or more second playback devices associated with the second location 206e.

In some instances, location indications can be provided on a per-location basis. Playback data corresponding to media content played back via multi-location media playback systems can comprise playback data corresponding to each location. For example, playback data received by the computing system for media playback system 204d can comprise first location playback data corresponding to media content played back via the multi-location media playback system 204d at the first location 206d and second location playback data corresponding to media content played back via the multi-location media playback system at the second location 206e. The computing system can receive the playback data for the different locations individually or in aggregate for the account. As mentioned before, the playback data can be received together with data identifying the location to which particular piece of data is associated. In this way, the computing system may be able to identify the particular location to be indicated to a particular user.

In some instances, the playback data similarity considered to indicate a particular location to a user comprises a similarity between the playback data corresponding to the user and the playback data corresponding to media content played back via the multi-location media playback system at one of its locations. The location indications can then comprise an indication of the particular location with which there is a similarity in playback data. In some instances, there is no relevant similarity between the playback data corresponding to the user and playback data corresponding to media content played back via the multi-location media playback system at another location. In this case, the one or more location indications corresponding to one or more locations can exclude an indication of the other location.

For example and as illustrated in the example of FIG. 2B, location 206d associated with media playback system 204d is indicated to the user 205a, but not location 206e. This can be because the media content played back at location 206d, as indicated by the playback data received by the computing system, may be more similar to media content consumed by the user 205a than media content played back at location 206e. Locations 206d and 206e can be different studios of a fitness chain, and the user may decide to go to studio 206d because of the type of music they play.

In some instances, the location of a multi-location media playback system that is indicated to a user may depend on other factors such as the physical location of the place and other data that characterizes the place. For example, locations 206d and 206e can play the same or similar media content, and location 206d is indicated to the user 205a because it is closer to a user's physical location, or because it is open now, etc.

In some instances, the computing system can, after receiving the playback data corresponding to media content played back by users via each media playback system, generate a preferences profile for each media playback system, or for each account, or for each user associated with an account or media playback system. In these cases, the location indications can be based on this preferences profile generated for the users. The preferences profile can indicate media content preferences for the user and can be generated by the computing system based on playback data. For example, the computing system can determine that the user likes a particular kind of content because the playback data indicates that the user plays back the particular content often, and/or that the user has played back the media content more than a threshold number of occasions over a particular time period, and/or that the user has saved the media content in one or more playlists, and/or that the user has indicated positive preferences for the media content (e.g., saved it as “favorite”, hit a like button, etc.), etc.

In some instances, the accounts in the first set of accounts 201 can be multi-user accounts. For example, the accounts can be family accounts or accounts that are otherwise used by two or more users. Similarly, in some instances, the media playback systems in the first set of media playback systems 203 can be multi-user media playback systems (e.g., used by two or more users). In these cases, each user may have their own preferences profile. In these cases, the location indications can be provided on a per-user basis.

As mentioned before, the location indications can be provided via a user interface associated with the respective accounts and/or media playback system. The user interface can be a user interface of a user device or playback device or any other device registered or otherwise associated with the account for which the location recommendations are provided. The user interface can be accessed via an application such as an application of the media playback system, a media streaming service application, a “places” recommendation application, or any other application. The user interface can also or alternative be a web user interface accessed via a web portal.

In some instances, the user interface comprises a graphical user interface that can be displayed in a display device (e.g., a display device registered with the account for which location indications are provided). In those instances, the location indications can be provided via the graphical user interface. For example, graphical representations corresponding to the location indications can be displayed on the graphical user interface. The user interface can also comprise a voice user interface. In some instances, location indications are played back to the user via media content such as audio or video. For example, audible representations corresponding to the location indications can be played back via a playback device.

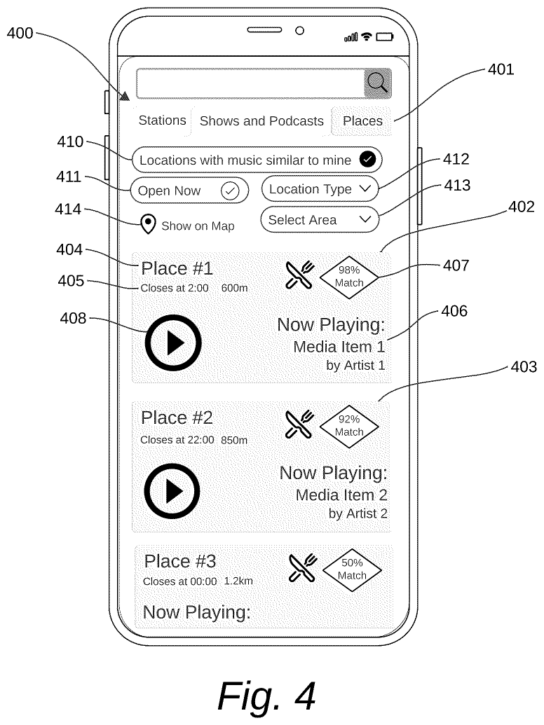

FIG. 4 illustrates an example user interface 400. The user interface 400 is displayed on a user device. The user interface can be the user interface of an application running on the user device (e.g., a controller application of the media playback system, a media streaming service application, etc.) or accessed via a web portal or web browser. In some instances, the user interface 400 is an instance of user interface 133 described with reference to FIG. 1H. The user interface 400 includes a locations option or tab 401, where one or more location indications such as location indications 402 and 403 can be provided. Each location indication can comprise one or more of a place or location identifier 404, location information 405, playback information 406, a score or strength indicator 407, a playback control 408, and/or any other data or options. User interface 400 further includes a set of location filtering options to filter and/or select locations based on different criteria, such as options 410, 411, 412, 413, 414.

User interface 400 comprises various options for the user to navigate the interface. In some instances, the user interface can provide a locations option, such as option 401, which can cause, when selected, the user interface to display location indications such as location indications 402 and 403. As illustrated, each location indication can comprise a place or location identifier 404 such as a location name. The location indication can also comprise location information 405 about the location, such as the time it closes, the address, how far away it is from the user, etc. The location indication can also comprise a score or strength indicator 407 indicating how strongly the location matches the user's preferences as determined from the playback data (e.g., as determined by the similarity engine).

In some instances, the location indication can also comprise playback information 406 about the content currently being played back at the corresponding location. The user may be able to tune in, sample, or preview the media content at the location via the location indication. For example, the location representation can be displayed with a playback option 408 that allows the user to listen to the media content played back at the location. Playback option 408 can, when selected, cause the user's media playback system or any device being used to view the location indications to play back at least a portion of the media content currently played back at the location. Examples of how to identify and/or mirror the media content played back at a different location are described in U.S. Pat. No. 10,587,693, filed Apr. 1, 2014, entitled “Mirrored Queues”, U.S. Pat. No. 9,674,587, filed Jun. 26, 2012, entitled “Systems and Methods for Networked Music Playback Including Remote add to Queue”, U.S. Pat. No. 9,891,880, filed Mar. 31, 2015, entitled “Information Display Regarding Playback Queue Subscriptions”, and U.S. Pat. No. 9,705,950, filed Apr. 3, 2014, entitled “Methods and Systems for Transmitting Playlists”, all of which are incorporated by reference herein in their entireties.

User interface 400 can also comprise options to filter or refine the set of location indications displayed. For example, the user interface can comprise a location filtering option 410 that allows the user to filter locations that play content similar to what the user likes. This option (and any other option in the user interface) can be enabled or disabled so that the user has freedom to select what they'd like to see in the user interface. Selecting location filtering option 410 can cause the user interface to display locations that are relevant to the particular user (e.g., as determined by method 300 in FIG. 3). Non-relevant locations can be optionally omitted from the user interface when option 410 is selected. In some examples, selecting location filtering option 410 can cause the location indications to be re-arranged or re-ordered so that locations with a higher matching score are displayed first.

User interface 400 comprises other location filtering options that enable the user to further curate the list of location recommendations provided. For example, condition selection option 411 can be selected to filter the location indications that meet a certain condition such as locations that are “open now”. As another example, location type selection option 412 can be selected to enter or select a location type (e.g., restaurants). As another example, area selection option 413 can be selected to enter or select an area of interest (e.g., nearby, in New York City, within 2 miles, etc.).

The location indications can additionally or alternatively be displayed on a map, as indicated by map option 414. For example, graphical representation corresponding to the locations can be overlaid on a map. The graphical representations can be color-coded or include the score or strength indicator 407 so that a user can easily identify locations that match their preferences. The graphical representations can be icons displayed on the map.

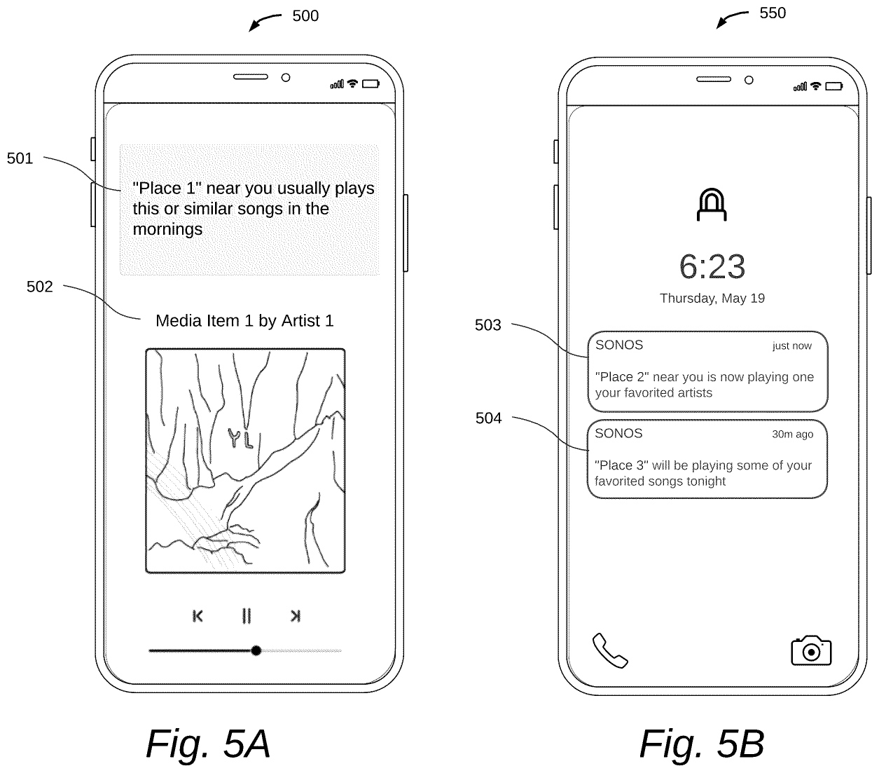

In some instances, the location indications can be provided proactively to the user. For example, the playback data corresponding to the first media playback system can comprise an indication of a media item currently being played back by a user via a particular media playback system or account. In this case, the location indications can be provided while the user is playing back the media item. FIG. 5A illustrates an example user interface where a location indication 501 is provided based on the media content 501 currently being played back by the user.

As another example, the playback data corresponding to a location can comprise indications of one or more media items currently being played back at the location (i.e., via the media playback system at the location). In that case, a location indication for this location can be provided to the user while the more media items are being played back via the media playback system at the indicated location. FIG. 5B illustrates an example user interface where a location indication 503 is provided based on the media content currently being played back at the indicated location.

In some instances, locations 206 can share a schedule of media content so that the computing system can provide an indication of media content that is going to be played back at the location at a particular time. FIG. 5B illustrates a location indication 504 provided based on the media content that will be played back at the indicated location at a future time. In some instances, the schedule comprises and/or can be derived from a playback queue comprising the media items to be played back by the location. The locations can share their schedule by making the schedule accessible to the computing system 200. In some instances, the schedule can be made accessible and/or shared with all users/accounts of computing system 200. In some instances, the schedule can be made accessible and/or shared with a subset of users/accounts. For example, users/accounts can subscribe to or follow particular locations for updates. Notifications corresponding to the schedule of these locations can be shared with those users/accounts. As illustrated in FIGS. 5A and 5B, location indications can be provided when the user is engaged with the user interface (FIG. 5A) and/or when the user is not engaged such as in a lock screen mode (FIG. 5B) or pop notifications when the applications is closed or in the background.

Location indications can be provided to the users in many other different ways. In one example, location indications can be provided to the user in the form of an advertisement. For example, the computer system can determine that a user may enjoy the media content played back at a particular location, and provide an advertisement of the particular location to the user. The advertisement can be provided in various ways such as via a notification, a message, an email, a social media feed, etc. In some instances, the advertisement can be played back by the user media playback system. A playlist can be linked to or embedded in the advertisement. In some instances, the advertisement can be played back together with other media content. For example, a user may be listening to a particular type of media content, and an advertisement of a location that is currently playing back and/or usually plays back similar content can be played back during an advertisement break or after a song finishes playing.

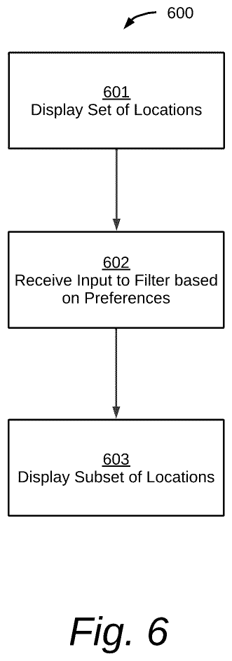

FIG. 6 illustrates a flowchart for a set of methods of displaying a user interface via which locations can be filtered based on the user's preferences. The method can be performed by any computing device such as a user device, that comprises a display, at least one processor and at least one non-transitory computer-readable medium comprising program instructions that are collectively executable by the at least one processor such that the user device is configured to conduct the method.

Flowchart 600 comprises a block 601 of displaying a graphical user interface corresponding to a user account registered with the user device. The graphical user interface can comprise one or more indications of a set of locations, and each location in the set of locations is associated with a media playback system. The user interface can be similar to the user interface illustrated in FIG. 4.

In some instances, the set of locations can be displayed based on an input. The input can comprise an indication of a search criteria. The search criteria can comprise one or more of an indication of a geographical area (nearby, in New York City, etc.), a type of location (restaurant, store, fitness center, etc.), a time frame (now, this evening, on Friday, before 8 AM, after 10 PM, etc.), a condition for the location (e.g., open now, pet friendly, WIFI available, etc.).

Flowchart 600 comprises block 602 of receiving (e.g., via the graphical user interface) an input to filter the set of locations based on a preferences profile associated with the user account. The input can be received, for example, via the selectable option 410 in FIG. 4. Flowchart 600 comprises a block 603 of displaying a subset of locations based on the input and on the preferences profile. The subset of locations provided in block 603 can be the locations determined to be relevant to the particular user as discussed with reference to method 300 in FIG. 3. The subset of locations can exclude at least one location from the set of locations originally displayed. In other words, filtering locations may cause the user interface to be updated to omit some of the locations that are not relevant to the filtering criteria.

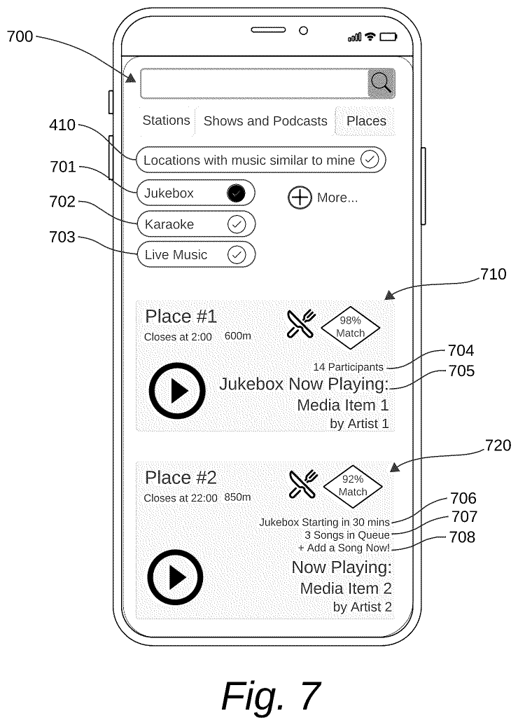

In some instances, the locations can offer one or more features that can be showcased to the users along with the location indications provided via the user interface. The user interface can include options to identify and/or filter locations based on one or more additional aspects or features. FIG. 7 illustrates an example user interface 700 comprising a set of location indications 710 and 720, and a set of feature selection options such as a jukebox selection option 701, a karaoke selection option 702 and a live music selection option 703.

In one example, the user interface provides a jukebox selection option 701 to find/filter locations that provide a jukebox feature or service where users can add media content for playback. In another example, the user interface provides a karaoke selection option 702 to find/filter locations that provide a karaoke feature or service where users can select media items to sing. As another example, the user interface provides a live music selection option 703 to find/filter locations that provide live music. Other examples are possible.

In the example user interface of FIG. 7, the jukebox selection option 701 is selected. Selection of this option can cause the set of location indications to be filtered to display or surface locations that provide this particular feature. As illustrated, the location indications (e.g., 710) can provide information about the particular feature such as the jukebox now playing indication 705, a number of participants 704, etc.

As mentioned before, in some instances places can provide a schedule of media content that can be used to provide location indications. The schedule can comprise a schedule of particular features available at the location. For example, a location such as a bar can schedule jukebox time every Saturday from 7 PM to 10 PM. The jukebox feature can then be enabled automatically at the scheduled time and can be indicated in the location indications in accordance with the time period where it is enabled. FIG. 7 illustrates an example location indication 720 comprising information 706 about the scheduled feature such as information of the time when the feature will be available, the time remaining until the feature is available, etc.

In some instances, a location can enable users to interact with the feature via the location indications. For example, users can add media content to a jukebox for playback via the location indication 720 via the add songs option 708. An indication 707 of the number of songs already added to the jukebox can also be provided. As illustrated in the example location indication 720, users can interact with the feature even if the feature is still not enabled by the schedule. Examples of how to remotely add content for playback are described in U.S. Pat. No. 9,674,587, filed Jun. 26, 2012, entitled “Systems and Methods for Networked Music Playback Including Remote add to Queue”, and in U.S. Pat. No. 9,705,950, filed Apr. 3, 2014, entitled “Methods and Systems for Transmitting Playlists”, all of which are incorporated by reference herein in their entireties.

In some instances, the locations can play back other media content while a particular feature is not enabled and/or if there are no users interacting with the particular feature. For example, outside of the jukebox time, the bar could play any other media content such as media content from a streaming service. Similarly, during the jukebox time, the bar could play other media content if there are no jukebox songs queued for playback. After the jukebox time has ended or a particular jukebox song added for playback has ended, the bar could go back to or resume playing back other media content.

When a user adds a song to the jukebox queue, the song can be played back immediately during the jukebox time if there are no other items in the jukebox queue. If the location was already playing content (e.g., while waiting for users to add content to the jukebox queue), the song added by the user can replace the content currently being played back either immediately or after the end of the song that is currently playing. If there are other items in the jukebox queue, the new song can be placed in order after any other items already added to the queue by other users. In some instances, users can vote to decide what media item is played first. Other considerations for features such as a jukebox re described in U.S. Pat. No. 9,977,561, filed Apr. 26, 2013, entitled “Systems, Methods, Apparatus, and Articles of Manufacture to Provide Guest Access”, which is incorporated by reference herein in its entirety.

In this way, the techniques described in this disclosure can be used not only to generally find locations that play back content that matches the user's preferences, but also to find locations that provide particular features or services. These techniques can be carried out without requiring physical presence of the user in the location, enabling the user to assess the media content and features of the location before going to the location. Furthermore, the techniques provided herein provide the user with the ability to find locations based on historical playback activity (e.g., what a location usually plays back and/or has played back in a particular period of time) and/or in real time based on current payback activity in the locations.

### IV. CONCLUSION

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

1. A computing system comprising:
at least one processor; and
at least one non-transitory computer-readable medium comprising program instructions that are collectively executable by the at least one processor such that the computing system is configured to:
receive, for a first set of media playback systems, playback data corresponding to media content played back via each media playback system in the first set of media playback systems;
receive, for a second set of media playback systems, playback data corresponding to media content played back via each media playback system in the second set of media playback systems, wherein each media playback system in the second set of media playback systems is associated with at least one location; and
based on at least one playback data similarity between: (i) playback data corresponding to a first media playback system from the first set of media playback systems, and (ii) playback data corresponding to one or more second media playback systems from the second set of media playback systems:
provide, via a user interface associated with the first media playback system, one or more location indications corresponding to one or more locations associated with the one or more second media playback systems.

2. The computing system of claim 1, wherein the second set of media playback systems comprises the one or more second media playback systems and at least one additional media playback system.

3. The computing system of claim 2, wherein the one or more location indications corresponding to the one or more locations exclude an indication corresponding to the at least one additional media playback system.

4. The computing system of claim 2, wherein the one or more location indications corresponding to the one or more locations exclude an indication corresponding to the at least one additional media playback system based on a lack of playback data similarity between: (i) playback data corresponding to the first media playback system and (ii) playback data corresponding to the at least one additional media playback system.

5. The computing system of claim 1, wherein the one or more second media playback systems exclude at least one media playback system from the second set of media playback systems.

6. The computing system of claim 1, wherein the at least one non-transitory computer-readable medium further comprises program instructions such that the computing system is configured to:
based on at least one playback data similarity between: (i) playback data corresponding to a third media playback system from the first set of media playback systems, and (ii) playback data corresponding to one or more fourth media playback systems from the second set of media playback systems:
provide, via a user interface associated with the third media playback system, one or more location indications corresponding to one or more locations associated with the one or more fourth media playback systems.

7. The computing system of claim 6, wherein:
the first media playback system is different from the third media playback system; and
the one or more second media playback systems and the one or more fourth media playback systems comprise at least one common media playback system.

8. The computing system of claim 6, wherein:
the first media playback system is different from the third media playback system; and
the one or more second media playback systems comprise at least one media playback system different from any of the one or more fourth media playback systems.

9. The computing system of claim 1, wherein the one or more second media playback systems comprise at least one multi-location media playback system which is associated with at least a first location and a second location.

10. The computing system of claim 9, wherein the at least one multi-location media playback system comprises at least one first playback device associated with the first location and at least one second playback device associated with the second location.

11. The computing system of claim 9, wherein the playback data corresponding to media content played back via the at least one multi-location media playback system comprises: (i) first location playback data corresponding to media content played back via the at least one multi-location media playback system at the first location, and (ii) second location playback data corresponding to media content played back via the at least one multi-location media playback system at the second location.

12. The computing system of claim 11, wherein:
the at least one playback data similarity comprises a similarity between the playback data corresponding to the first media playback system and the first location playback data corresponding to media content played back via the at least one multi-location media playback system at the first location; and
the one or more location indications corresponding to the one or more locations comprise an indication of the first location.

13. The computing system of claim 11, wherein:
the at least one playback data similarity excludes a similarity between the playback data corresponding to the first media playback system and the second location playback data corresponding to media content played back via the at least one multi-location media playback system at the second location; and
the one or more location indications corresponding to one or more locations exclude an indication of the second location.

14. The computing system of claim 1, wherein the playback data corresponding to the first media playback system comprises an indication of a media item currently being played back via the first media playback system.

15. The computing system of claim 14, wherein providing the one or more location indications corresponding to one or more locations comprises providing the one or more location indications while the first media playback system is playing back the media item.

16. The computing system of claim 1, wherein the playback data corresponding to the one or more second media playback systems comprises an indication of respective one or more media items currently being played back via the one or more second media playback systems.

17. The computing system of claim 16, wherein providing the one or more location indications corresponding to one or more locations comprises providing the one or more location indications while one or more of the respective one or more media items are being played back via the one or more second media playback systems.

18. The computing system of claim 1, wherein each of the one or more locations is associated with one or more of: a respective location name; a respective location address; or a respective local area network (LAN).

19. A non-transitory computer-readable medium, wherein the non-transitory computer-readable medium is provisioned with program instructions that, when executed by at least one processor, cause a computing system to:
receive, for a first set of media playback systems, playback data corresponding to media content played back via each media playback system in the first set of media playback systems;
receive, for a second set of media playback systems, playback data corresponding to media content played back via each media playback system in the second set of media playback systems, wherein each media playback system in the second set of media playback systems is associated with at least one location; and
based on at least one playback data similarity between: (i) playback data corresponding to a first media playback system from the first set of media playback systems, and (ii) playback data corresponding to one or more second media playback systems from the second set of media playback systems:
provide, via a user interface associated with the first media playback system, one or more location indications corresponding to one or more locations associated with the one or more second media playback systems.

20. A method carried out by a computing system, the method comprising:
receiving, for a first set of media playback systems, playback data corresponding to media content played back via each media playback system in the first set of media playback systems;
receiving, for a second set of media playback systems, playback data corresponding to media content played back via each media playback system in the second set of media playback systems, wherein each media playback system in the second set of media playback systems is associated with at least one location; and
based on at least one playback data similarity between: (i) playback data corresponding to a first media playback system from the first set of media playback systems, and (ii) playback data corresponding to one or more second media playback systems from the second set of media playback systems:
providing, via a user interface associated with the first media playback system, one or more location indications corresponding to one or more locations associated with the one or more second media playback systems.
